(19) United States
(12) Patent Application Publication
(10) Pub. No.: US 2017/0136298 A1
(43) Pub. Date: May 18, 2017

(54) METHOD AND APPARATUS FOR GENERATING EXERCISE PROGRAM OR PROVIDING EXERCISE FEEDBACK

(71) Applicant: Samsung Electronics Co., Ltd., Suwon-si (KR)

(72) Inventors: SangKon BAE, Seongnam-si (KR); Byunghoon KO, Hwaseong-si (KR); Dae-Geun JANG, Yongin-si (KR)

(73) Assignee: Samsung Electronics Co., Ltd., Suwon-si (KR)

(21) Appl. No.: 15/142,596

(22) Filed: Apr. 29, 2016

(30) Foreign Application Priority Data
Nov. 13, 2015 (KR) 10-2015-0159421

(51) Int. Cl. A63B 24/00; G09B 5/02; G09B 19/00

(52) U.S. Cl. CPC A63B 24/0062; G09B 19/0038; G09B 5/02

(57) ABSTRACT

A method and an apparatus for generating an exercise program and/or providing an exercise feedback are provided. A method of generating an exercise program involves receiving profile information and body information of a user, the body information being associated with an exercise ability of the user, and generating by a processor an exercise program based on the profile information and the body information.

### CROSS-REFERENCE TO RELATED APPLICATION(S)

This application claims the benefit under 35 USC 119(a) of Korean Patent Application No. 10-2015-0159421, filed on Nov. 13, 2015 in the Korean Intellectual Property Office, the entire disclosure of which is incorporated herein by reference for all purposes.

### BACKGROUND

1. Field

The following description relates to a method and an apparatus for facilitating exercise. For example, the following description relates to a method and an apparatus for generating an exercise program and a method and an apparatus for providing an exercise feedback.

2. Description of Related Art

An exercise program may be generated based on heart rate information. An exercise program that is generated based on the heart rate information may not include a physical fitness level of an individual in the exercise program. Further, a user may need to wear a device to measure the heart rate information to monitor or manage an exercise intensity. An exercise ability of an individual may be evaluated and an exercise program may be generated based on the evaluated exercise ability. In this case, a device for evaluating the individual exercise ability, such as an ECG, may be needed separately and a physician or a physical therapist may be need to interpret the measurement obtained from the device.

### SUMMARY

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

In one general aspect, a method of generating an exercise program involves receiving profile information and body information of a user, the body information being associated with an exercise ability of the user, and generating by a processor an exercise program based on the profile information and the body information.

The general aspect of the method may further involve calculating a target speed based on the profile information, and selecting an exercise pattern corresponding to the body information based on exercise pattern data stored in a memory. The generating may involve generating the exercise program based on the target speed and the selected exercise pattern.

The generating may involve adjusting exercise intensity information included in the selected exercise pattern based on the target speed.

The body information may include obesity information and physical fitness level information, and the general aspect of the method may further involve selecting an exercise pattern matching the obesity information and the physical fitness level information based on exercise pattern data stored in a memory.

The receiving may involve displaying a plurality of items of physical fitness level information on a display, and selecting physical fitness level information corresponding to a selection input from the plurality of items of physical fitness level information.

The general aspect of the method may further involve selecting exercise patterns corresponding to a plurality of items of physical fitness level information using obesity information included in the body information based on exercise pattern data stored in a memory, and the generating may involve generating a plurality of exercise programs corresponding to the selected exercise patterns.

The general aspect of the method may further involve displaying the plurality of exercise programs on a display, and selecting an exercise program corresponding to a selection input from the plurality of exercise programs.

The general aspect of the method may further involve measuring an exercise-physiological index of the user, and mapping one of a plurality of items of physical fitness level information and a physical fitness level of the user verified based on the measured exercise-physiological index.

The general aspect of the method may further involve verifying a physical fitness level of the user performing an exercise based on the exercise program, and updating the exercise program based on the verified physical fitness level.

The general aspect of the method may further involve outputting the exercise program in at least one of a visual output, an auditory output, and a tactile output.

The calculating may involve selecting an exercise-physiological index corresponding to the profile information based on a database in which a plurality of exercise-physiological indices is stored, calculating a target exercise-physiological index based on the selected exercise-physiological index, and calculating the target speed based on the target exercise-physiological index.

The exercise-physiological index may include a maximal oxygen uptake.

In another general aspect, a method of providing an exercise feedback involves verifying exercise performance information of a user by using a processor to analyze an exercise performed by the user, comparing the exercise performance information to an exercise program generated based on profile information and body information of the user, the body information being associated with an exercise ability of the user, and providing a feedback to the user based on a result of the comparing.

The providing of the feedback may involve outputting an exercise coaching message generated based on the result of the comparing in at least one of a visual output, an auditory output, and a tactile output.

The providing may involve displaying a reference object corresponding to the exercise program and a performance object corresponding to the exercise performance information on a display.

The exercise program may be generated based on a target speed calculated based on the profile information and an exercise pattern selected in correspondence to the body information.

The exercise program may be generated by adjusting exercise intensity information included in the exercise pattern based on the target speed.

The target speed may be calculated based on a target exercise-physiological index corresponding to an exercise-physiological index of the user selected using the profile information.

The exercise-physiological index may include a maximal oxygen uptake of the user.

In another general aspect, an exercise program generating apparatus includes an interface device configured to receive profile information and body information of a user, the body information being associated with an exercise ability of the user, and a processor configured to generate an exercise program based on the profile information and the body information.

The processor may be further configured to provide an exercise feedback to the user by comparing exercise performance information of the user to the exercise program generated based on the profile information and the body information.

Other features and aspects will be apparent from the following detailed description, the drawings, and the claims.

### BRIEF DESCRIPTION OF THE DRAWINGS

FIG. 1 illustrates an example of a method of generating an exercise program.

FIG. 2 illustrates an example of a method of generating an exercise program using exercise pattern data.

FIGS. 3A through 3E illustrate examples of exercise programs.

FIGS. 4 through 6 illustrate other examples of methods of generating an exercise program.

FIG. 7 illustrates an example of a method of providing an exercise feedback.

FIGS. 8 through 10 illustrate examples of apparatuses that provide a feedback.

FIG. 11 illustrates an example of an apparatus that generates an exercise program.

FIG. 12 illustrates another example of an apparatus that generates an exercise program.

Throughout the drawings and the detailed description, unless otherwise described or provided, the same drawing reference numerals will be understood to refer to the same elements, features, and structures. The drawings may not be to scale, and the relative size, proportions, and depiction of elements in the drawings may be exaggerated for clarity, illustration, and convenience.

### DETAILED DESCRIPTION

The following detailed description is provided to assist the reader in gaining a comprehensive understanding of the methods, apparatuses, and/or systems described herein. However, various changes, modifications, and equivalents of the methods, apparatuses, and/or systems described herein will be apparent to one of ordinary skill in the art. The sequences of operations described herein are merely examples, and are not limited to those set forth herein, but may be changed as will be apparent to one of ordinary skill in the art, with the exception of operations necessarily occurring in a certain order. Also, descriptions of functions and constructions that are well known to one of ordinary skill in the art may be omitted for increased clarity and conciseness.

The features described herein may be embodied in different forms, and are not to be construed as being limited to the examples described herein. Rather, the examples described herein have been provided so that this disclosure will be thorough and complete, and will convey the full scope of the disclosure to one of ordinary skill in the art.

Hereinafter, reference will now be made in detail to examples with reference to the accompanying drawings, wherein like reference numerals refer to like elements throughout.

Various alterations and modifications may be made to the examples. Here, the examples are not construed as limited to the disclosure and should be understood to include all changes, equivalents, and replacements within the idea and the technical scope of the disclosure.

The terminology used herein is for the purpose of describing various examples only and is not intended to limit the disclosure. As used herein, the singular forms “a”, “an”, and “the” are intended to include the plural forms as well, unless the context clearly indicates otherwise. It will be further understood that the terms “include/comprise” and/or “have” when used in this specification, specify the presence of stated features, integers, steps, operations, elements, components, and/or combinations thereof, but do not preclude the presence or addition of one or more other features, numbers, steps, operations, elements, components, and/or groups thereof.

Unless otherwise defined, all terms including technical and scientific terms used herein have the same meaning as commonly understood by one of ordinary skill in the art to which examples belong. It will be further understood that terms, such as those defined in commonly-used dictionaries, should be interpreted as having a meaning that is consistent with their meaning in the context of the relevant art and will not be interpreted in an idealized or overly formal sense unless expressly so defined herein.

When describing the examples with reference to the accompanying drawings, like reference numerals refer to like constituent elements and a repeated description related thereto will be omitted. When it is determined detailed description related to a related known function or configuration they may make the purpose of the examples unnecessarily ambiguous in describing the examples, the detailed description will be omitted here.

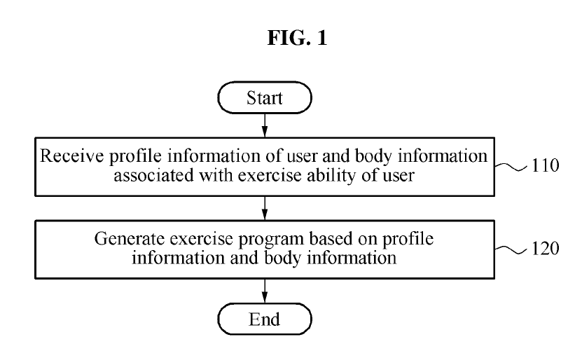

FIG. 1 illustrates an example of a method of generating an exercise program.

The exercise program generating method may be performed by an exercise program generating apparatus.

Referring to FIG. 1, in operation 110, an exercise program generating apparatus receives profile information and body information of a user. The body information is associated with an exercise ability of the user. The profile information includes, for example, a height, a gender, an age, a weight, or a combination thereof. The body information associated with the exercise ability includes, for example, obesity information, physical fitness level information, or a combination thereof. Physical fitness level information includes, for example, information regarding a time period during which the user performed a preset intensity of exercise. As an example, when the user performs a high intensity exercise for a relatively long period of time, the physical fitness level information of the user corresponds to a high level. When the user performs an intermediate/low intensity exercise for a relatively short period of time, the physical fitness level information of the user corresponds to a relatively low level.

In operation 120, the exercise program generating apparatus generates an exercise program based on the profile information and the body information. The exercise program generating apparatus generates a personalized exercise program based on, for example, one of the height, the gender, the age, the weight, a degree of obesity, and a physical fitness level, or a combination thereof. Hereinafter, an example of generating an exercise program will be described. The following descriptions are provided as an example, and it is thus not intended to limit the present description.

The exercise program generating apparatus calculates a target speed based on the profile information.

The exercise program generating apparatus selects an exercise-physiological index corresponding to the profile information to calculate the target speed.

The exercise program generating apparatus refers to the physiological index database in which a plurality of exercise-physiological indices is stored. In the physiological index database, a maximal oxygen uptake, VO₂_{_}ₘₐₓ is stored based on the gender and/or the age. The exercise program generating apparatus selects VO₂_{_}ₘₐₓ corresponding to the gender and/or the age of the user. As an example, when the user is a male in his twenties, the exercise program generating apparatus selects 45 milliliters of oxygen per kilogram of body mass per minute (ml/kg/min) based on the physiological index database. As another example, when the user is a female in her twenties, the exercise program generating apparatus selects 38 ml/kg/min based on the physiological index database.

The exercise program generating apparatus calculates a target exercise-physiological index based on the selected exercise-physiological index. The target exercise-physiological index indicates an appropriate exercise intensity. For example, the exercise program generating apparatus calculates one value in a range between 50% and 60% of the selected VO₂_{_}ₘₐₓ as a target VO₂. Thus, 22.5 ml/kg/min corresponding to 50% of 45 ml/kg/min is calculated as the target VO₂. Also, 19.5 ml/kg/min corresponding to 50% of 38 ml/kg/min is calculated as the target VO₂.

The exercise program generating apparatus calculates the target speed using the target exercise-physiological index. The target speed indicates, for example, an appropriate exercise speed corresponding to the gender and/or the age of the user. As an example, the exercise program generating apparatus calculates the target speed based on Equation 1.

Target VO₂=3.5+(0.2×Target speed)+(0.9×Target speed)×grade [Equation 1]

The target speed is expressed as shown in Equation 2.

Target speed=(Target VO₂−3.5)/(0.2+grade) [Equation 2]

In Equations 1 and 2, the grade indicates a gradient. For example, when a gradient of the exercise program generating apparatus is 10%, the grade is 0.1.

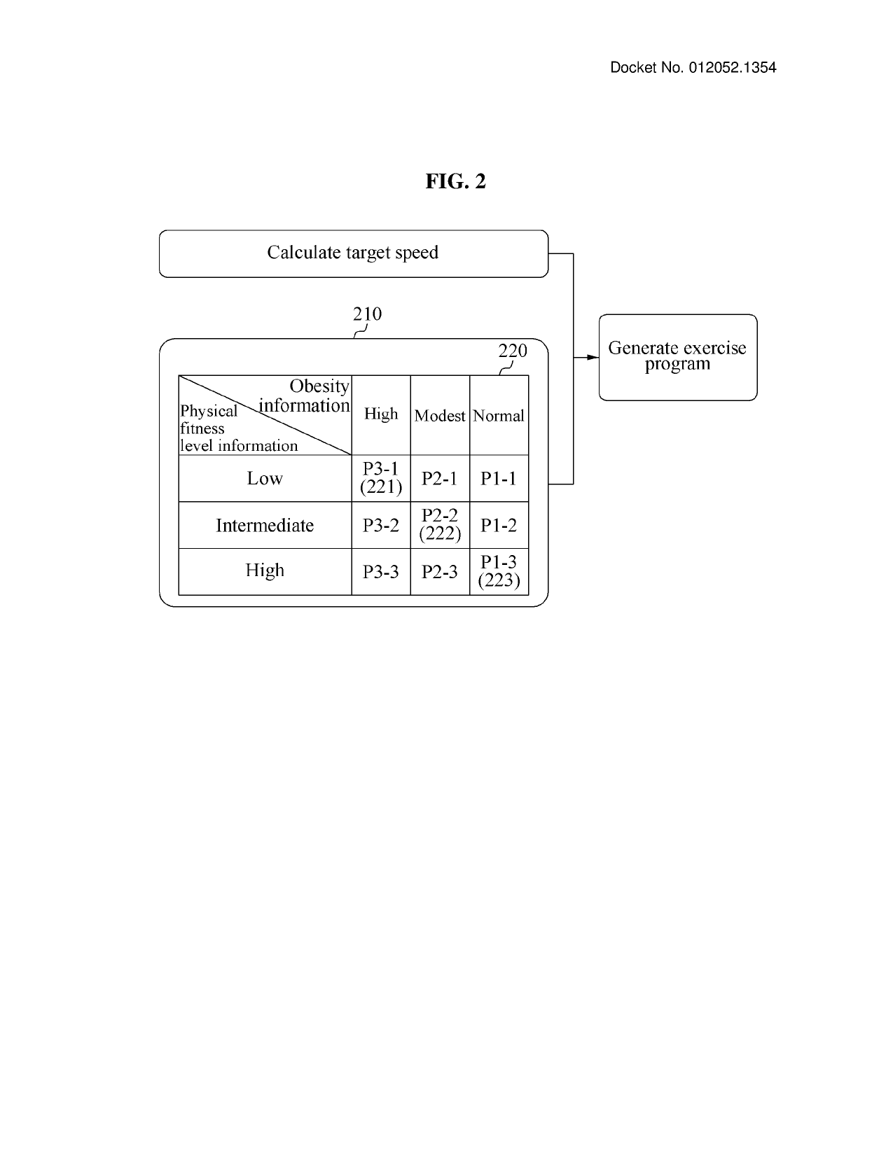

The exercise program generating apparatus selects an exercise pattern corresponding to the body information based on exercise pattern data stored in a memory. The exercise pattern data may be stored in a format of a table in which a plurality of exercise patterns is recorded. Hereinafter, related descriptions will be provided with reference to FIG. 2.

FIG. 2 illustrates an example of a method of generating an exercise program using an exercise pattern.

Referring to FIG. 2, an exercise program generating apparatus refers a table 220 in which exercise pattern data is recorded. The table 220 is stored in an exercise pattern database 220.

The plurality of exercise patterns is classified based on physical fitness level information and obesity information. Referring to FIG. 2, the plurality of exercise patterns is classified based on a case in which the physical fitness level information corresponds to a high level, an intermediate level, and a low level and a case in which the obesity information corresponds to a high level, a modest level, and a normal level.

The exercise program generating apparatus selects an exercise pattern matching the physical fitness level information and the obesity information of the user. As an example, when the obesity information corresponds to the high level and the physical fitness level information corresponds to the low level, the exercise program generating apparatus selects an exercise pattern 221. As another example, when the obesity information corresponds to the modest level and the physical fitness level information corresponds to the intermediate level, the exercise program generating apparatus selects an exercise pattern 222. As still another example, when the obesity information corresponds to the normal level and the physical fitness level information corresponds to the high level, the exercise program generating apparatus selects an exercise pattern 223.

The descriptions related to a classification of the plurality of exercise pattern are provided as an example, and an example of the classification of the plurality of exercise pattern is not limited thereto.

The exercise program generating apparatus generates an exercise program based on the target speed and the selected exercise pattern. The exercise program generating apparatus adjust an exercise intensity by applying the target speed to the exercise pattern.

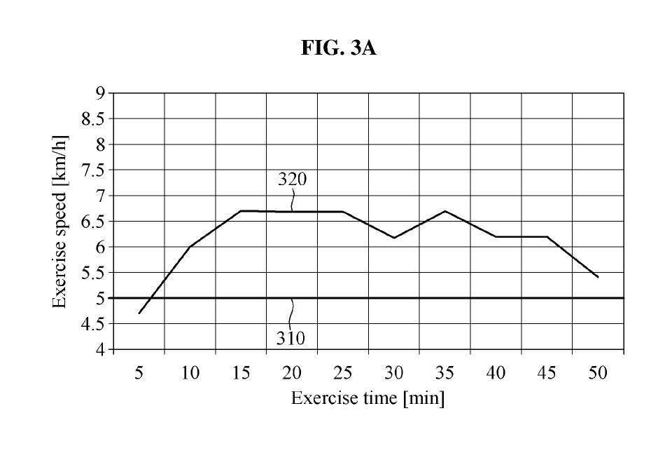

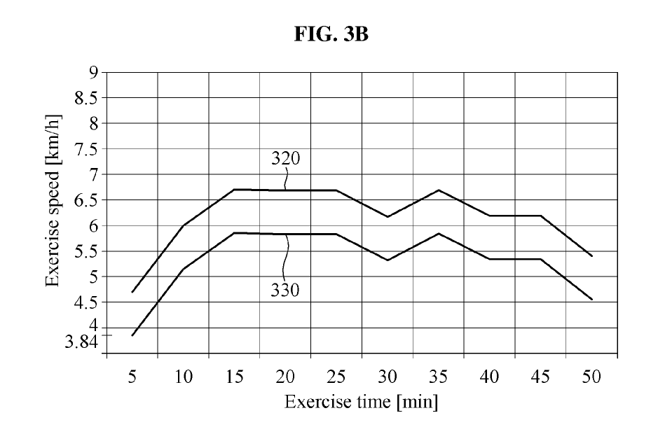

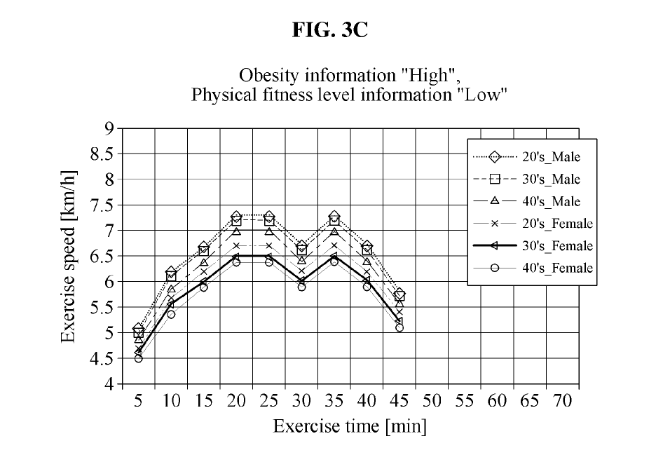

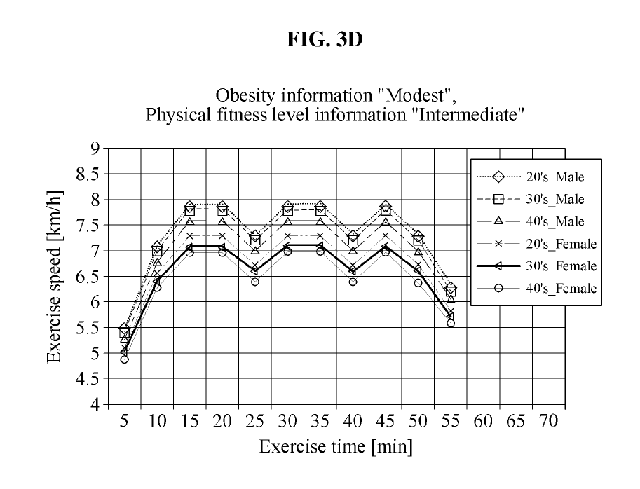

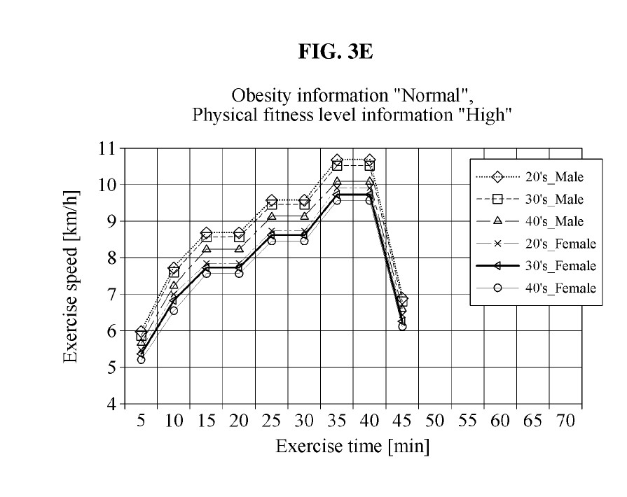

The exercise pattern includes, for example, exercise time information and exercise intensity information. The exercise intensity information includes, for example, exercise speed information. The exercise program generating apparatus adjusts the exercise intensity information based on the target speed. Hereinafter, related descriptions will be provided with reference to FIGS. 3A and 3B.

FIGS. 3A through 3E illustrate examples of an exercise program. FIG. 3A illustrates a target speed 310 and an exercise pattern 320. A typical exercise pattern includes a warming-up portion, a main portion, and a cooling-down exercise, and the present exercise pattern includes a pattern having intervals or a pattern in which a preset intensity is maintained based on a purpose of exercise. Thus, the exercise pattern varies based on the physical fitness level, a degree of obesity, and the purpose of exercise, and an exercise intensity also varies to prevent a user from experiencing a tedium during an exercise interval. In an example of the exercise pattern 320, a minimum value of exercise speed is 4.8 kilometers per hour (km/h). An exercise program generating apparatus adjusts exercise intensity information included in the exercise pattern 320 based on the target speed 310. For example, the exercise program generating apparatus adjusts a minimum exercise speed of the exercise pattern 320 to a value corresponding to a preset rate of the target speed 310. When the preset rate is 80% and the target speed 310 is calculated as 5 km/h, the minimum value of exercise speed is adjusted from 4.8 km/h to 3.84 km/h. In this example, exercise speed information of the exercise pattern is adjusted based on the adjusted minimum value. Thus, an exercise program in which an overall level of exercise pattern is lowered down may be generated. When a target speed is calculated as 7 km/h, the minimum value of exercise speed is adjusted from 4.8 km/h to 5.6 km/h. In this example, an exercise program in which an overall level of exercise pattern is increased up.

FIG. 3B illustrates an exercise program 330 generated by the exercise program generating apparatus.

Referring to FIG. 3B, a minimum value of exercise speed of the exercise program 330 is 4.8 km/h to which 3.84 km/h is adjusted. When compared to FIG. 3A, an overall level of the exercise program 330 is lowered down from the overall level of the exercise pattern 320.

The target speeds, the exercise patterns, and the exercise programs of FIGS. 3A and 3B are described as an example, and thus an example of a target speed, an exercise patterns, and an exercise program is not limited to the aforementioned descriptions.

FIGS. 3C through 3E illustrate examples of an exercise program to be generated by the exercise program generating apparatus.

FIG. 3C illustrates an exercise program corresponding to an age and a gender of a user of which physical fitness level information corresponds to a low level and obesity information corresponds to a high level.

FIG. 3D illustrates an exercise program corresponding to an age and a gender of a user of which physical fitness level information corresponds to an intermediate level and obesity information corresponds to a modest level.

FIG. 3E illustrates an exercise program corresponding to an age and a gender of a user of which physical fitness level information corresponds to a high level and obesity information corresponds to a normal level.

The exercise programs of FIGS. 3C through 3E are described as an example, and thus an example of an exercise program to be generated by the exercise program generating apparatus is not limited to the aforementioned descriptions.

The exercise program generating apparatus outputs the generated exercise program.

The exercise program generating apparatus visually output the exercise program on a display. As an example, the exercise program generating apparatus display the exercise program 330 of FIG. 3B on the display. The exercise program generating apparatus outputs the exercise program through an auditory output. As an example, in response to the generating of the exercise program 330 of FIG. 3B, the exercise program generating apparatus outputs a voice, for example, “run at 3.84 km/h when starting exercise”. The exercise program generating apparatus outputs the exercise program through a tactile manner. As an example, when the exercise program generating apparatus is implemented as a wearable device and in contact with a user, the exercise program generating apparatus outputs a vibration based on an exercise speed of the exercise program.

The exercise program generating apparatus generates an exercise program based on at least one of a gender, an age, a degree of obesity, and a physical fitness level. Through this, the exercise program generating apparatus generates a personalized exercise program or a user-customized exercise program.

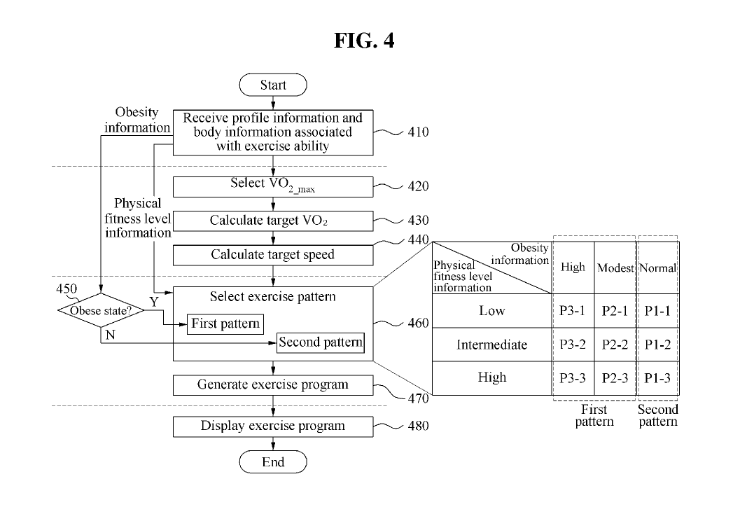

FIGS. 4 through 6 illustrate other examples of methods of generating an exercise program. The methods of generating an exercise program described with reference to FIGS. 4 through 6 is performed by an exercise program generating apparatus.

Referring to FIG. 4, in operation 410, an exercise program generating apparatus receives profile information and body information of a user. The body information is associated with an exercise ability of the user. As in the foregoing examples described with reference to FIGS. 1-3E, the body information includes physical fitness level information of the user. The exercise program generating apparatus displays a plurality of items of physical fitness level information on a display to receive the physical fitness level information of the user, thereby allowing the user to select one of the plurality of items of physical fitness level information. For example, the exercise program generating apparatus may display a high level, an intermediate level, and a low level of physical fitness to allow the user to select one level among the high level, the intermediate level, and the low level. The plurality of items of physical fitness level information classified into the high level, the intermediate level, and the low level is described as an example, the physical fitness level information is not limited thereto.

The description provided above with reference to FIG. 1 also applies to operations 420 through 440 of FIG. 4. Thus, repetitive descriptions will be omitted.

In operation 450, the exercise program generating apparatus verifies whether obesity information matches a preset condition. In operation 460, the exercise program generating apparatus selects a first pattern in response to the obesity information indicating an obese state, and the exercise program generating apparatus selects a second pattern in response to the obesity information indicating a normal state. The first pattern includes an exercise pattern based on a degree of obesity. In response to the first pattern being selected, the exercise program generating apparatus selects an exercise pattern corresponding to the obesity information and the physical fitness level information from a plurality of exercise patterns included in the first pattern. In response to the second pattern being selected, the exercise program generating apparatus selects an exercise pattern corresponding to the obesity information and the physical fitness level information from a plurality of exercise patterns included in the second pattern.

The above description provided with reference to FIG. 1 also applies to operations 470 and 480 of FIG. 4. Accordingly, repetitive descriptions will be omitted.

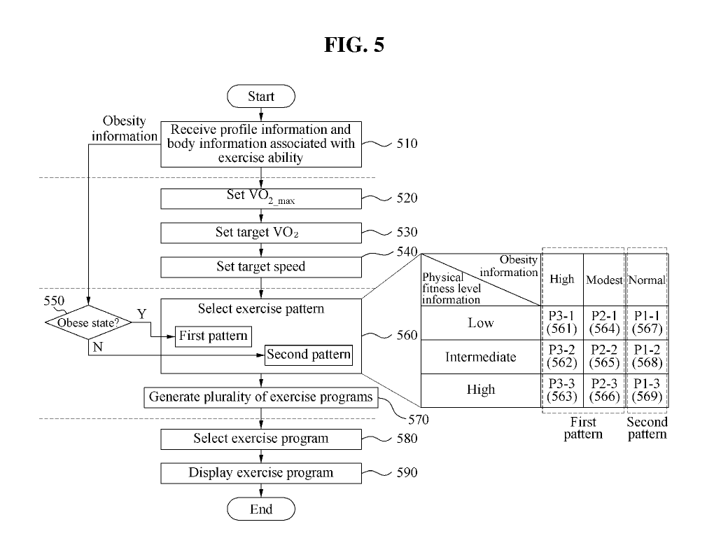

Referring to FIG. 5, in operation 510, the exercise program generating apparatus receives profile information and body information of a user. The body information is associated with an exercise ability of the user. In contrast to an example illustrated in FIG. 4, the body information of the user received by the exercise program generating apparatus does not include physical fitness level information. Thus, the exercise program generating apparatus generates a plurality of exercise programs without receiving physical fitness level information of the user. In operation 560, the exercise program generating apparatus selects an exercise pattern corresponding to each of a plurality of physical fitness levels based on obesity information of the user. In this example, the exercise program generating apparatus selects exercise patterns 561 through 563 in response to the obesity information corresponding to a high level, and selects exercise patterns 564 through 566 in response to the obesity information corresponding to a modest level. In the event that the obesity information corresponds to a normal level, the exercise program generating apparatus selects exercise patterns 567 through 569.

The exercise program generating apparatus generates an exercise program corresponding to each of the selected exercise programs based on a target speed. In this example, in response to the obesity information corresponds to a high level, the exercise program generating apparatus generates an exercise program corresponding to each of the exercise patterns 561 through 563 based on the target speed. For example, an exercise program of which exercise speed information of the exercise pattern 561 is adjusted based on the target speed is generated, and an exercise program of which exercise speed information of the exercise pattern 562 is adjusted based on the target speed is generated. Also, an exercise program of which exercise speed information of the exercise pattern 563 is adjusted based on the target speed is generated. In operation 570, the exercise program generating apparatus generates a plurality of exercise programs.

In operation 580, the exercise program generating apparatus displays the plurality of exercise programs on a display to allow the user to select one of the plurality of exercise programs. The user selects one of the plurality of exercise programs based on a physical fitness level, a preference, and/or a condition. In response to a selection input of the user, the exercise program generating apparatus determines an exercise program to be provided to the user among the plurality of exercise programs.

In operation 590, the exercise program generating apparatus displays the exercise program.

The above description related to operations 420 through 450 also applies to operations 520 through 550 of FIG. 5. Thus, repetitive descriptions thereof will be omitted for conciseness.

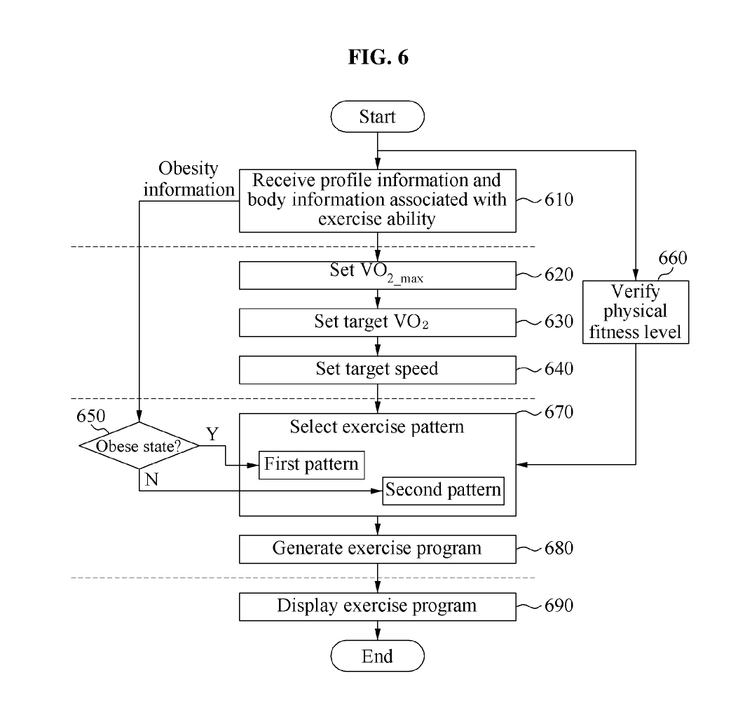

Referring to FIG. 6, in operation 610, the exercise program generating apparatus receives profile information and body information of a user. The body information is associated with an exercise ability of the user. In contrast to an example of FIG. 4, the exercise program generating apparatus does not receive physical fitness level information of the user in an example of FIG. 6. Also, in contrast to an example of FIG. 5, the exercise program generating apparatus does not generate a plurality of exercise programs in an example of FIG. 6. In operation 660, the exercise program generating apparatus verifies a physical fitness level of the user.

In an example, the exercise program generating apparatus measures an exercise-physiological index of the user. The exercise-physiological index includes, for example, one of a maximum heart rate, a maximal oxygen uptake, and a heart rate variability (HRV), or a combination thereof. The exercise program generating apparatus is in contact with a portion, for example, a wrist of a body of the user to measure the maximal heart rate. Based on an implementation, the exercise program generating apparatus includes a physical device, for example, a sensor configured to measure the exercise-physiological index.

The exercise program generating apparatus maps the verified physical fitness level to one of a plurality of items of physical fitness level information. For example, the exercise program generating apparatus maps the verified physical fitness level to one of a high level, an intermediate level, and a low level. In operation 670, the exercise program generating apparatus selects an exercise pattern based on physical fitness information and obesity information.

Because the descriptions related to operations 420 through 450 and 460 through 480 are also applicable here, repeated descriptions of operations 610 through 650 and 670 through 690 will be omitted.

The exercise program generating apparatus verifies an exercise physical fitness level of a user performing an exercise based on the generated exercise program by measuring an exercise-physiological index of the user. In this example, the physical fitness information of the user is not applied to the generated exercise program. The exercise program generating apparatus maps the verified physical fitness level to one of the plurality of items of physical fitness level information. Through this, the exercise program generating apparatus acquires the physical fitness information of the user. The exercise program generating apparatus updates the exercise program based on the physical fitness level information. The physical fitness level information of the user is applied to the updated exercise program.

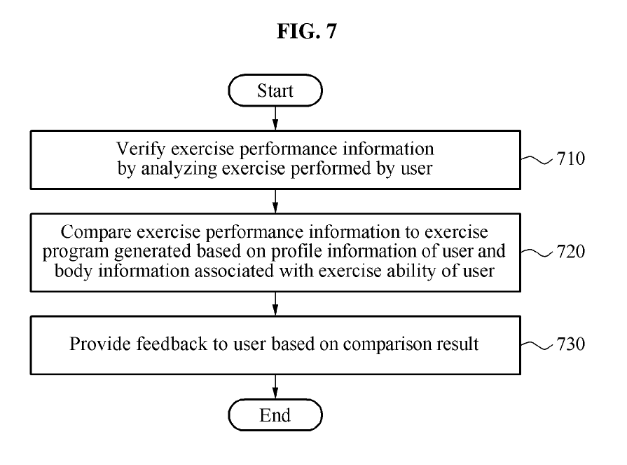

FIG. 7 illustrates an example of a method of providing an exercise feedback.

The exercise feedback providing method is performed by an exercise feedback providing apparatus.

Referring to FIG. 7, in operation 710, the exercise feedback providing apparatus verifies exercise performance information by analyzing an exercise performed by the user. The exercise performance information includes, for example, one of an exercise distance, an exercise time, and an exercise speed of the user, or a combination thereof. In an example, the exercise feedback providing apparatus measures a location of the user using a location sensor, for example, a global positioning system (GPS) sensor, and verifies the exercise distance of the user based on the location. The exercise feedback providing apparatus verifies the exercise speed based on the exercise time and the exercise distance. Also, the exercise feedback providing apparatus verifies the exercise speed of the user using an acceleration sensor.

In operation 720, the exercise feedback providing apparatus compares the exercise performance information to an exercise program. The exercise program is generated based on profile information and body information of the user, the body information being associated with an exercise ability of the user. The descriptions related to a generation of the exercise program are also applicable here and thus, repeated descriptions will be omitted.

The exercise feedback providing apparatus compares the exercise speed of the user to an exercise speed of the exercise program. Through this, the exercise feedback providing apparatus verifies whether the user performs an exercise corresponding to the exercise program.

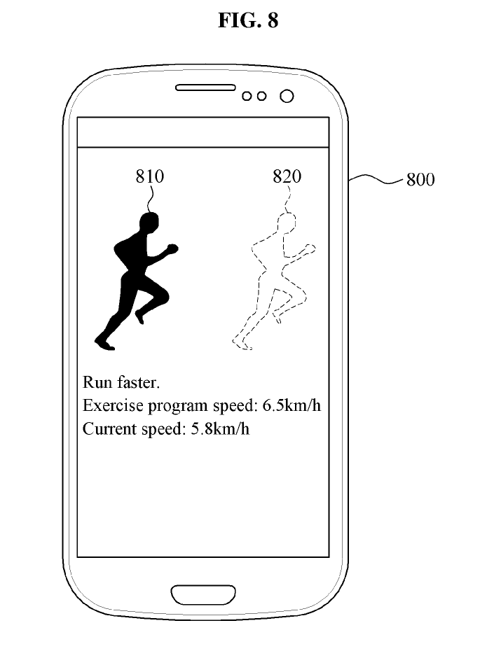

In operation 730, the exercise feedback providing apparatus provides a feedback to the user based on a comparison result. The exercise feedback providing apparatus generates an exercise coaching message based on the comparison result. The exercise feedback providing apparatus generates the exercise coaching message indicating, for example, “run faster”. The exercise feedback providing apparatus outputs the exercise coaching message through at least one of a visual output, an auditory output, and a tactile output. Hereinafter, the feedback provided to the user will be described as an example with reference to FIGS. 8 through 10.

Since the descriptions provided with reference to FIGS. 1 through 6 are also applicable here, repeated descriptions with respect to FIG. 7 will be omitted.

FIGS. 8 through 10 illustrate examples of a feedback.

A terminal 800 generates an exercise program based on profile information and body information input by a user. The descriptions related to a generation of the exercise program are also applicable here and thus, repeated descriptions will be omitted. Also, the terminal 800 receives an exercise program generated by an exercise program generating apparatus physically differing from the terminal 800.

Referring to FIG. 8, a visual feedback is displayed on a display of the terminal 800. In this example, the exercise feedback providing apparatus is the terminal 800 or included in the terminal 800.

Exercise performance information is displayed on the display. In an example, an exercise speed of the user is displayed on the display. Additionally, an exercise speed of the exercise program is displayed on the display.

The display also displays a performance object 810 corresponding to the exercise performance information and a reference object 820 corresponding to the exercise program. As illustrated in FIG. 8, when the user performs an exercise at a speed lower than the exercise speed of the exercise program, the reference object 820 is displayed ahead of the performance object 810. In this example, the exercise feedback providing apparatus outputs a speed-up message on the display. When the user performs an exercise at a speed higher than the exercise speed of the exercise program, the performance object 810 is displayed ahead of the reference object 820. In this example, the exercise feedback providing apparatus outputs a speed-down message on the display.

Based on the visual feedback, the user verifies whether a current exercise being performed by the user corresponds to the exercise program. Based on a result of the verifying, the user increases or reduces the exercise speed to correspond to the exercise program.

Since the descriptions provided with reference to FIGS. 1 through 7 are also applicable here, repeated descriptions with respect to FIG. 8 will be omitted.

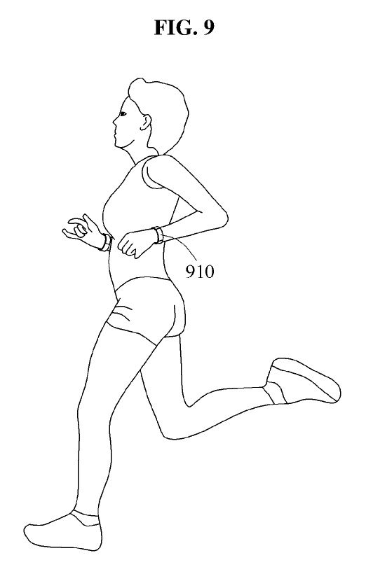

Referring to FIG. 9, a user wears a wearable device 910 and performs an exercise.

The wearable device 910 generates an exercise program based on profile information and body information input by a user. The descriptions related to a generation of the exercise program are also applicable here and thus, repeated descriptions will be omitted. Also, the wearable device 910 receives an exercise program generated by an exercise program generating apparatus physically differing from the wearable device 910.

The exercise feedback providing apparatus is the wearable device 910 or included in the wearable device 910. In FIG. 9, the wearable device 910 is provided in a watch type as an example, and a type of the wearable device 910 is not limited thereto.

The wearable device 910 includes a location sensor and/or an acceleration sensor. The exercise feedback providing apparatus verifies an exercise speed of the user based on information output from the location sensor and/or the acceleration sensor.

When the exercise speed of the user does not correspond to the exercise program, the exercise feedback providing apparatus provides a feedback to the user. As an example, the exercise feedback providing apparatus outputs a sensory feedback based on a first output pattern indicating a speed-up message. In this example, the user increases the exercise speed. When the exercise speed of the user corresponds to the exercise program, the exercise feedback providing apparatus suspends the outputting of the sensory feedback. As another example, the exercise feedback providing apparatus outputs a sensory feedback based on a second output pattern indicating a speed-down message. In this example, the user reduces the exercise speed. When the exercise speed of the user corresponds to the exercise program, the exercise feedback providing apparatus suspends the outputting of the sensory feedback.

Since the descriptions provided with reference to FIGS. 1 through 8 are also applicable here, repeated descriptions with respect to FIG. 9 will be omitted.

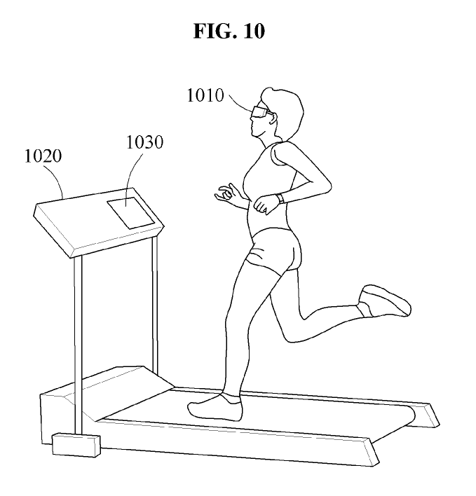

Referring to FIG. 10, a user wears a wearable device 1010 and performs an exercise using a healthcare instrument 1020.

The wearable device 1010 generates an exercise program based on profile information and body information input by a user. The descriptions related to a generation of the exercise program are also applicable here and thus, repeated descriptions will be omitted. Also, the wearable device 1010 receives an exercise program generated by an exercise program generating apparatus physically differing from the wearable device 1010. For example, the wearable device 1010 receives an exercise program generated by the healthcare instrument 1020.

In FIG. 10, the wearable device 1010 is provided in a glasses type and the healthcare instrument 1020 is a treadmill as an example, and a type of the wearable device 1010 and an example of the healthcare instrument 1020 is not limited thereto.

The healthcare instrument 1020 includes a display 1030. The exercise program is displayed on at least one of the display 1030 and a display of the wearable device 1010.

The wearable device 1010 verifies an exercise speed of the user corresponds to the exercise program. Based on a verification, the wearable device 1010 provides a feedback to the user. When the exercise speed of the user is lower than an exercise speed of the exercise program, the wearable device 1010 provides at least one of a visual feedback, an auditory feedback, and a sensory feedback. For example, the wearable device 1010 outputs a message for increasing a speed of the healthcare instrument 1020. The wearable device 1010 transmits the message to the healthcare instrument 1020 through a wired communication network or a wireless communication network. The healthcare instrument 1020 increases a speed in response to the message.

Also, the wearable device 1010 displays a reference object and a performance object on the display of the wearable device 1010. Through this, the user verifies that the exercise speed does not correspond to the exercise program and increases the speed of the healthcare instrument 1020, thereby increasing the exercise speed.

Since the descriptions of FIGS. 1 through 9 are also applicable here, repeated descriptions with respect to FIG. 10 will be omitted.

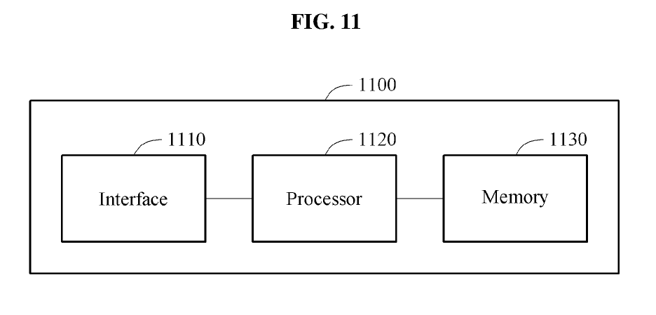

FIG. 11 illustrates an example of an exercise program generating apparatus.

In an example, the exercise program generating apparatus is a mobile terminal, for example, a smartphone, a tablet personal computer (PC), and a wearable device. In another example, the exercise program generating apparatus is a stationary terminal, for example, a PC. In still another example, the exercise program generating apparatus is implemented in a form of a chip to be included in the mobile terminal and/or the stationary terminal.

Referring to FIG. 11, an exercise program generating apparatus 1100 includes an interface device 1110, a processor 1120, and a memory 1130. According to one example, the exercise program generating apparatus 1100 may be implemented in a wearable device, a mobile terminal such as a smart phone, or in a wearable device that communicates with a mobile terminal. However, the implementation is not limited thereto.

The memory 1130 stores an application for generating an exercise program. The processor 1120 executes the application.

In response to an execution of the application, the interface device 1110 receives profile information of a user and body information associated with an exercise ability of the user. The interface device 1110 allows an interaction between the user and the exercise program generating apparatus 1100. The interface device 1110 includes, for example, a keyboard, a display, a touchscreen, and a mouse. For example, the exercise program generating apparatus 1100 may include a touchscreen through which a visual feedback may be provided.

The processor 1120 generates an exercise program based on the profile information and the body information.

The exercise program generating apparatus 1100 may further include a communication interface to communicate with an external device. The communication interface includes wireless Internet interfaces such as a wireless local area network (WLAN), a wireless fidelity (Wi-Fi) direct, a digital living network alliance (DLNA), a wireless broadband (WiBro), a world interoperability for microwave access (WiMAX), and a high speed downlink packet access (HSDPA), for example, and short-range communication interfaces such as Bluetooth, a radio frequency identification (RFID), an infrared data association (IrDA), a ultra wideband (UWB), ZigBee, and a near field communication (NFC). The communication interface also includes wired interfaces.

The exercise program generating apparatus 1100 transmits the exercise program to an external device through a communication interface. The external device includes, for example, at least one of the stationary terminal, the mobile terminal, and a healthcare instrument. As an example, the exercise program generating apparatus 1100 transmits a generated exercise program to the healthcare instrument. The healthcare instrument monitors whether a user performs an exercise based on the exercise program.

Since the descriptions provided with reference to FIGS. 1 through 10 are also applicable here, repeated descriptions with respect to FIG. 11 will be omitted.

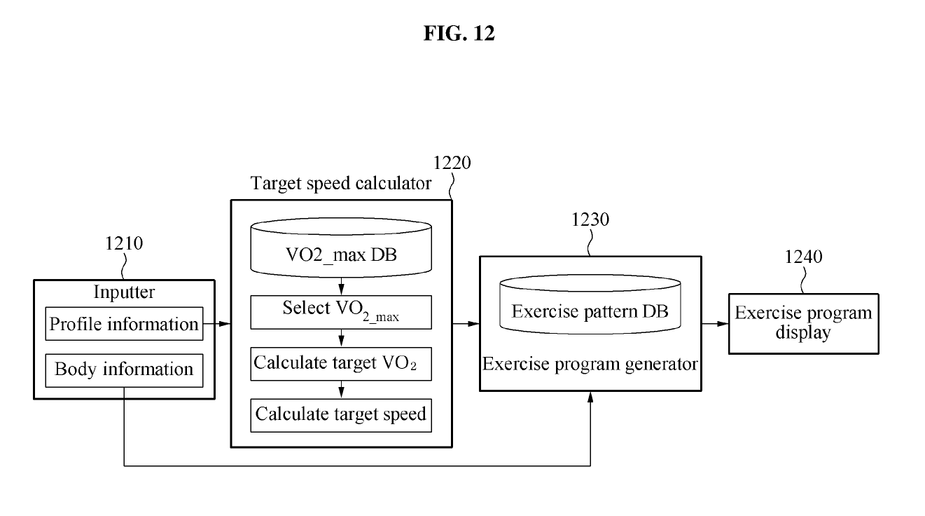

FIG. 12 illustrates another example of an exercise program generating apparatus.

Referring to FIG. 12, an exercise program generating apparatus includes an input device 1210, a target speed calculator 1220, an exercise program generator 1230, and an exercise program display 1240. According to one example, the exercise program generating apparatus may be implemented in a wearable device, a mobile terminal such as a smart phone, or in a wearable device that communicates with a mobile terminal. However, the implementation is not limited thereto.

The input device 1210 receives profile information and body information of a user. The body information is associated with an exercise ability of the user. The input device 1210 corresponds to the interface device 1110 of FIG. 11.

The target speed calculator 1220, the exercise program generator 1230, and the exercise program display 1240 are operated by the processor 1120 of FIG. 11.

Since the descriptions provided with reference to FIGS. 1 through 11 are also applicable here, repeated descriptions with respect to FIG. 12 will be omitted.

The apparatuses, units, modules, devices, calculators, and other components illustrated in FIGS. 11 and 12 that perform the operations described herein with respect to FIGS. 1, 2 and 4-7 are implemented by hardware components. Examples of hardware components include controllers, sensors, generators, drivers, memories, comparators, arithmetic logic units, adders, subtractors, multipliers, dividers, integrators, and any other electronic components known to one of ordinary skill in the art. In one example, the hardware components are implemented by computing hardware, for example, by one or more processors or computers. A processor or computer is implemented by one or more processing elements, such as an array of logic gates, a controller and an arithmetic logic unit, a digital signal processor, a microcomputer, a programmable logic controller, a field-programmable gate array, a programmable logic array, a microprocessor, or any other device or combination of devices known to one of ordinary skill in the art that is capable of responding to and executing instructions in a defined manner to achieve a desired result. In one example, a processor or computer includes, or is connected to, one or more memories storing instructions or software that are executed by the processor or computer. Hardware components implemented by a processor or computer execute instructions or software, such as an operating system (OS) and one or more software applications that run on the OS, to perform the operations described herein with respect to FIGS. 1, 2 and 4-7. The hardware components also access, manipulate, process, create, and store data in response to execution of the instructions or software. For simplicity, the singular term “processor” or “computer” may be used in the description of the examples described herein, but in other examples multiple processors or computers are used, or a processor or computer includes multiple processing elements, or multiple types of processing elements, or both. In one example, a hardware component includes multiple processors, and in another example, a hardware component includes a processor and a controller. A hardware component has any one or more of different processing configurations, examples of which include a single processor, independent processors, parallel processors, single-instruction single-data (SISD) multiprocessing, single-instruction multiple-data (SIMD) multiprocessing, multiple-instruction single-data (MISD) multiprocessing, and multiple-instruction multiple-data (MIMD) multiprocessing.

The methods illustrated in FIGS. 1, 2 and 4-7 may be performed by a processor or a computer as described above executing instructions or software to perform the operations described herein.

Instructions or software to control a processor or computer to implement the hardware components and perform the methods as described above are written as computer programs, code segments, instructions or any combination thereof, for individually or collectively instructing or configuring the processor or computer to operate as a machine or special-purpose computer to perform the operations performed by the hardware components and the methods as described above. In one example, the instructions or software include machine code that is directly executed by the processor or computer, such as machine code produced by a compiler. In another example, the instructions or software include higher-level code that is executed by the processor or computer using an interpreter. Programmers of ordinary skill in the art can readily write the instructions or software based on the block diagrams and the flow charts illustrated in the drawings and the corresponding descriptions in the specification, which disclose algorithms for performing the operations performed by the hardware components and the methods as described above.

The instructions or software to control a processor or computer to implement the hardware components and perform the methods as described above, and any associated data, data files, and data structures, are recorded, stored, or fixed in or on one or more non-transitory computer-readable storage media. Examples of a non-transitory computer-readable storage medium include read-only memory (ROM), random-access memory (RAM), flash memory, CD-ROMs, CD-Rs, CD+Rs, CD-RWs, CD+RWs, DVD-ROMs, DVD-Rs, DVD+Rs, DVD-RWs, DVD+RWs, DVD-RAMs, BD-ROMs, BD-Rs, BD-R LTHs, BD-REs, magnetic tapes, floppy disks, magneto-optical data storage devices, optical data storage devices, hard disks, solid-state disks, and any device known to one of ordinary skill in the art that is capable of storing the instructions or software and any associated data, data files, and data structures in a non-transitory manner and providing the instructions or software and any associated data, data files, and data structures to a processor or computer so that the processor or computer can execute the instructions. In one example, the instructions or software and any associated data, data files, and data structures are distributed over network-coupled computer systems so that the instructions and software and any associated data, data files, and data structures are stored, accessed, and executed in a distributed fashion by the processor or computer.

While this disclosure includes specific examples, it will be apparent to one of ordinary skill in the art that various changes in form and details may be made in these examples without departing from the spirit and scope of the claims and their equivalents. The examples described herein are to be considered in a descriptive sense only, and not for purposes of limitation. Descriptions of features or aspects in each example are to be considered as being applicable to similar features or aspects in other examples. Suitable results may be achieved if the described techniques are performed in a different order, and/or if components in a described system, architecture, device, or circuit are combined in a different manner, and/or replaced or supplemented by other components or their equivalents. Therefore, the scope of the disclosure is defined not by the detailed description, but by the claims and their equivalents, and all variations within the scope of the claims and their equivalents are to be construed as being included in the disclosure.

What is claimed is:

1. A method of generating an exercise program, the method comprising:
receiving profile information and body information of a user, the body information being associated with an exercise ability of the user; and
generating by a processor an exercise program based on the profile information and the body information.

2. The method of claim 1, further comprising:
calculating a target speed based on the profile information; and
selecting an exercise pattern corresponding to the body information based on exercise pattern data stored in a memory,
wherein the generating comprises generating the exercise program based on the target speed and the selected exercise pattern.

3. The method of claim 2, wherein the generating comprises adjusting exercise intensity information included in the selected exercise pattern based on the target speed.

4. The method of claim 1, wherein the body information comprises obesity information and physical fitness level information, and
the method further comprises selecting an exercise pattern matching the obesity information and the physical fitness level information based on exercise pattern data stored in a memory.

5. The method of claim 1, wherein the receiving comprises:
displaying a plurality of items of physical fitness level information on a display; and
selecting physical fitness level information corresponding to a selection input from the plurality of items of physical fitness level information.

6. The method of claim 1, further comprising:
selecting exercise patterns corresponding to a plurality of items of physical fitness level information using obesity information included in the body information based on exercise pattern data stored in a memory,
wherein the generating comprises generating a plurality of exercise programs corresponding to the selected exercise patterns.

7. The method of claim 6, further comprising:
displaying the plurality of exercise programs on a display; and
selecting an exercise program corresponding to a selection input from the plurality of exercise programs.

8. The method of claim 1, further comprising:
measuring an exercise-physiological index of the user; and
mapping one of a plurality of items of physical fitness level information and a physical fitness level of the user verified based on the measured exercise-physiological index.

9. The method of claim 1, further comprising:
verifying a physical fitness level of the user performing an exercise based on the exercise program; and
updating the exercise program based on the verified physical fitness level.

10. The method of claim 1, further comprising:
outputting the exercise program in at least one of a visual output, an auditory output, and a tactile output.

11. The method of claim 2, wherein the calculating comprises:
selecting an exercise-physiological index corresponding to the profile information based on a database in which a plurality of exercise-physiological indices is stored;
calculating a target exercise-physiological index based on the selected exercise-physiological index; and
calculating the target speed based on the target exercise-physiological index.

12. The method of claim 11, wherein the exercise-physiological index includes a maximal oxygen uptake.

13. A method of providing an exercise feedback, the method comprising:
verifying exercise performance information of a user by using a processor to analyze an exercise performed by the user;
comparing the exercise performance information to an exercise program generated based on profile information and body information of the user, the body information being associated with an exercise ability of the user; and
providing a feedback to the user based on a result of the comparing.

14. The method of claim 13, wherein the providing of the feedback comprises outputting an exercise coaching message generated based on the result of the comparing in at least one of a visual output, an auditory output, and a tactile output.

15. The method of claim 13, wherein the providing comprises displaying a reference object corresponding to the exercise program and a performance object corresponding to the exercise performance information on a display.

16. The method of claim 13, wherein the exercise program is generated based on a target speed calculated based on the profile information and an exercise pattern selected in correspondence to the body information.

17. The method of claim 16, wherein the exercise program is generated by adjusting exercise intensity information included in the exercise pattern based on the target speed.

18. The method of claim 13, wherein the target speed is calculated based on a target exercise-physiological index corresponding to an exercise-physiological index of the user selected using the profile information.

19. The method of claim 18, wherein the exercise-physiological index comprises a maximal oxygen uptake of the user.

20. An exercise program generating apparatus comprising:
an interface device configured to receive profile information and body information of a user, the body information being associated with an exercise ability of the user; and
a processor configured to generate an exercise program based on the profile information and the body information.

21. The apparatus of claim 20, wherein the processor is further configured to provide an exercise feedback to the user by comparing exercise performance information of the user to the exercise program generated based on the profile information and the body information.
